(19) United States
(12) Patent Application Publication
(10) Pub. No.: US 2005/0202995 A1
(43) Pub. Date: Sep. 15, 2005

(54) Methods of treating surfaces using surface-treating compositions containing sulfonated/carboxylated polymers

(75) Inventors: Leslie Dawn Waits, Cincinnati, OH (US); Kenneth Nathan Price, Cincinnati, OH (US); Penny Sue Dirr, Fairborn, OH (US); Eva Schneiderman, Mason, OH (US); Howard David Hutton, Oregonia, OH (US); Alan Edward Sherry, Cincinnati, OH (US); Phillip Kyle Vinson, Fairfield, OH (US); Klein Aloysius Rodrigues, Chattanooga, TN (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/076,817

(22) Filed: Mar. 10, 2005

Related U.S. Application Data
(60) Provisional application No. 60/553,066, filed on Mar. 15, 2004.

(51) Int. Cl. C11D 3/00

(52) U.S. Cl. 510/475

(57) ABSTRACT

A method of treating a domestic, institutional, industrial, and/or commercial surface, the method comprising the step of contacting a surface with a surface-treating composition containing a water-soluble, sulfonated/carboxylated polymer, is provided.

### CROSS REFERENCE TO RELATED APPLICATION

This application claims the benefit of U.S. Provisional Application No. 60/553,066, filed Mar. 15, 2004.

### TECHNICAL FIELD

This invention is in the field of treating surfaces with cleaning and/or rinsing compositions. More particularly, the invention relates to surface-treating compositions, methods, and compositions of matter, and articles of manufacture containing a water-soluble, sulfonated/carboxylated polymer.

### BACKGROUND OF THE INVENTION

In certain surface-treating compositions and methods, polymers may serve many useful functions. They can function, either independently or concurrently, as thickeners in liquid detergents, as viscosity reducers in the processing of granular detergents, as anti-redeposition agents, as scale and deposit inhibitors, as crystal modifiers, and as detergent assistants which are capable of completely or partially replacing the materials used as builders, while imparting to surfactants optimum properties with respect to detergent actions.

In certain applications, use of polycarboxylate polymers may help to reduce hard water filming on substrate surfaces. These polycarboxylate polymers may be derived from (meth)acrylic acids and salts, as well as, from mixtures of such polymers with other compounds and/or polymers, such as phosphonic acids. Copolymers of (meth)acrylic acids and vinyl esters (such as, methyl methacrylate (MMA), ethyl acrylate (EA), hydroxy ethyl methacrylate and hydroxy propyl acrylate), copolymers of (meth)acrylic acids and salts with acrylamido alkyl, aryl sulfonates, or unsubstituted acrylamides, and terpolymers, formed from acrylic acid, 2-acrylamido-2-methyl propane sulfonic acid (AMPS) or unsubstituted acrylamide, are also useful in automatic dishwashing compositions. Polymers comprising polycarboxylates are described in U.S. Pat. Nos. 4,745,154; 5,547,612; and 5,591,703.

Recently, several hydrophobic polymers have been developed and are described in U.S. Pat. Nos. 5,489,397; 5,021,525; 5,534,198; 5,698,512; 5,798,324; 6,395,185; 6,114,294; 4,711,725; and 6,395,185. Sulfonated/carboxylated polymers may exhibit greater levels of hydrophobicity than that seen in conventional polycarboxylates polymers, however, these polymers may be expensive to manufacture, and especially with a high degree of sulfonation (e.g. 4 mole % and greater).

With regard to the use of some nonionic, amide- and ester-containing monomers in certain automatic dishwashing compositions, this can be actually very problematic. For example, some MMA-containing or AMPS-containing sulfonated/carboxylated polymers are unstable in chlorinated liquid automatic dishwashing compositions (especially in gels having a high pH often losing their performance after a couple of weeks in solution. While not wishing to be bound by theory, it is believed that in certain automatic washing detergents these polymers may be subject to attack by chlorine bleach because of the presence of the nitrogen in the amido functionality (such as, in AMPS) or the hydrolysis of the ester linkage (such as, in MMA).

Thus, there remains a long-standing need for surface-treating compositions that comprise more cost-effective polymers. The sulfonated/carboxylated polymers described herein can be used to clean and/or rinse a variety of hard surfaces with good cleaning performance while having less filming, spotting, and/or streaking. For example, these polymers can be used in automatic dishwashing rinse aid compositions, including but not limited to acidic formulations, to help to reduce hard water filming and spotting on tableware surfaces. In some liquid hard surface cleaners (such as, medium-duty detergent compositions or light-duty liquid dishwashing detergents), these polymers can act as an effective hydrotrope to reduce filming and streaking on all types of bathroom and kitchen surfaces, such as tableware, countertops, appliances, fixtures, floors, walls, windows, mirrors, shower doors, etc. These polymers may also be used in other acidic formulations, for example, to clean and/or rinse car surfaces.

Since the sulfonated/carboxylated polymers described herein may contain low sulfonate functionality, they can be more cost-effective than conventional sulfonated/carboxylated polymers with higher sulfonation. When used in a variety of consumer products, these cost-effective polymers provide many consumer benefits. For example, these polymers can be used as processing aids during blending, drying and agglomerating operations, thereby providing uniform distribution of the detergent composition's components, desired particle size and density, as well as, other desirable attributes during manufacture and storage of detergents, especially in powdered detergents (such as, detergent tablets, granulated compact detergents, granulated automatic dishwashing detergents, and heavy-duty granulated or granular laundry detergents).

Since sulfonated/carboxylated polymers with low sulfonation also provide improved stability performance in the presence of chlorine bleach, they are ideally suited for certain chlorinated and/or highly alkaline detergent compositions (such as liquid or granular, dishwashing detergents and heavy-duty laundry detergents). In the wash liquor, these polymers are believed to perform as a dispersant, co-builder and anti-soil redeposition agent, for both hard surfaces (e.g. tableware) and soft surfaces (e.g. laundry). These polymers are also believed to improve detergency by acting as a co-builder in reducing soil redeposition and water hardness salt deposition in soft surface cleaning applications, as well as, to function as a dispersant, especially in reduced and/or nil builder laundry formulations.

There also remains a need for sulfonated/carboxylated polymers that are hydrophobically modified, inexpensive and yet provide good anti-spotting and anti-filming performance over a broad pH range. Soluble builders, such as conventional hydrotropes, may be added as coupling agents to liquid detergent compositions to improve performance but the use of conventional hydrotropes may be expensive. Another cost-effective approach involves the use of hydrophobically-modified, sulfonated/carboxylated polymers comprising a nonionic functionality that is aimed at permitting interaction with a structured surfactant, thereby giving a stable, concentrated, low viscosity, built, liquid surface-treating composition. Hydrophobically modified, sulfonated/carboxylated polymers outperform conventional hydrotropes by providing an improved stability over a wide range of pH (e.g. both high and low pH formulations). In fact, these hydrophobically-modified, sulfonated/carboxylated polymers offer more flexibility in formulating effective surface-treating compositions than conventional polymers since they may also comprise any suitable level of sulfonate and/or carboxylic acid functionality.

### SUMMARY OF THE INVENTION

In one aspect of the present invention, a method of treating a domestic, institutional, industrial, and/or commercial surface is provided. The method may comprise the step of contacting the surface with a surface-treating composition comprising: (a) an effective amount of a water-soluble, sulfonated/carboxylated polymer comprising: (i) at least one carboxylic acid functionality; (ii) optionally, one or more nonionic functionality; and (iii) at least one sulfonate functionality, wherein the sulfonate functionality is less than 4 mole % of the molar content of the polymer; and (b) balance adjunct ingredients.

In another aspect of the present invention, a method of treating a domestic, institutional, industrial, and/or commercial surface is provided. The method may comprise the step of contacting the surface with a surface-treating composition comprising: (a) an effective amount of a water-soluble, sulfonated/carboxylated polymer comprising: (i) from about 0.01 mole % to about 99.98 mole % of one or more nonionic functionality; (ii) from about 0.01 mole % to less than 99.98 mole % of at least one sulfonate functionality; and (iii) from about 99.98 mole % to about 0.01 mole % of a carboxylic acid functionality; and (b) balance adjunct ingredients.

In another aspect of the present invention, a method of manufacturing an article of manufacture comprising a kit is provided. The method may comprise the step of providing a kit for domestic, institutional, industrial, and/or commercial consumption. The kit may comprise: (a) a package; (b) a surface-treating composition described herein; and (c) instructions for treating a surface using the composition. The surface-treating composition described herein may comprise an automatic dishwashing detergent composition, a rinse aid composition, a heavy-duty or laundry detergent composition, a light-duty liquid detergent composition, or a hard surface cleaning composition.

In another aspect of the present invention, a method of treating a domestic, institutional, industrial, and/or commercial surface is provided. The method may comprise the step of contacting the surface with a composition of matter comprising wash and/or rinse water provided by a cleaning device. The wash and/or rinse water may comprises from about 1 ppm to about 10,000 ppm, by concentration, of a surface-treating composition described herein.

### DETAILED DESCRIPTION OF THE INVENTION

Definitions

The sulfonated/carboxylated polymers described herein may be provided in any suitable form including, but not limited to: copolymers, terpolymers, tetrapolymers, interpolymers, and combinations thereof. As used herein the term “copolymer” defines a polymer formed from two monomers, the term “terpolymer” defines a polymer formed from three monomers, the term “tetrapolymer” defines a polymer formed from four monomers, and the term “interpolymer” defines a polymer formed from at least five monomers.

The term “surface,” as used herein, encompasses all suitable domestic, institutional, industrial, and/or commercial surfaces that may be cleaned or rinsed. Suitable surfaces include, but are not limited to: hard surfaces, soft surfaces, and combinations thereof. These surfaces may be natural, synthetic, porous, non-porous, woven, non-woven, and combinations thereof. Suitable surfaces include, but are not limited to: glass, plastic, ceramic, metal, fabric, wood, and combinations thereof. Suitable hard surfaces include, but are not limited to: tableware, countertops, furniture, floors, walls, containers, showers, doors, windows, cars, buildings, etc.

The term “tableware,” as used herein, encompasses all surfaces used for storing, cooking, serving, and eating food. These tableware surfaces include, but are not limited to: glassware, plasticware, dishware, non-stick cooking surfaces, utensils, etc. Suitable soft surfaces include, but are not limited to: fabrics, linens, clothes, towels, drapes, upholstery, carpets, etc. The term “laundry” as used herein, encompasses all articles of clothing worn by consumers.

The term “effective amount,” as used herein, refers to an amount that is sufficient to improve cleaning and/or rinsing of all types of surfaces under normal conditions, or alternatively an amount that is sufficient to reduce hard water filming, streaking, and/or spotting on hard substrate surfaces, to improve whiteness and/or cleaning or to reduce staining and/or soil redeposition on soft surfaces, to improve dispersion of the surface-treating composition in an aqueous medium, such as in wash and/or rinse water, and/or to provide improved product stability performance, especially in the presence of chlorine bleach and high pH.

The term “cleaning device,” as used herein, refers to any type of domestic, institutional, industrial, and/or commercial device that is used for cleaning and/or rinsing any suitable surface, such as those described herein. For example, suitable cleaning devices include, but are not limited to: automatic dishwashing (ADW) machines, automatic washing machines for laundry, automatic car wash machines, sinks, buckets, pressure washers, garden hose attachments, and combinations thereof. The cleaning device may be portable, semi-portable, or fixed (such as, a fixture). For example, a hand-held cleaning device (e.g. spray washer, mop, etc.) could comprise any suitable sulfonated/carboxylated polymer containing-fluid source (e.g. fluid container, water line, water hose, etc.).

Sulfonated/Carboxylated Polymers

This invention is useful for treating surfaces with compositions, methods compositions of matter, and articles of manufacture comprising a surface-treating composition. The surface-treating compositions described herein may comprise any suitable sulfonated/carboxylated polymer described herein in any suitable amount. In one non-limiting embodiment, the surface-treating composition may comprise from about 0.01% to about 100%, or from about 0.01% to about 99%, or from about 0.01% to about 95%, or from about 0.01% to about 90%, or from about 0.01% to about 80%, or from about 0.01% to about 70%, or from about 0.01% to about 60%, or from about 0.01% to about 50%, or from about 0.01% to about 40%, or from about 0.01% to about 30%, or from about 0.01% to about 20%, or from about 0.01% to about 10%, or from about 0.01% to about 5%, or from about 0.01% to about 4%, or from about 0.01% to about 3%, or from about 0.01% to about 2%, or alternatively from about 0.01% to about 1%, by weight of the composition, of a suitable sulfonated/carboxylated polymer described herein.

Suitable sulfonated/carboxylated polymers described herein may have a weight average molecular weight of less than or equal to about 100,000 Da, or less than or equal to about 75,000 Da, or less than or equal to about 50,000 Da, or from about 10,000 Da to about 50,000, or from about 15,000 Da to about 50,000 Da; or from about 20,000 Da to about 50,000 Da, or alternatively from about 25,000 Da to about 50,000 Da.

As noted herein, the sulfonated/carboxylated polymers may comprise (a) at least one structural unit derived from at least one carboxylic monomer having the general formula (I): 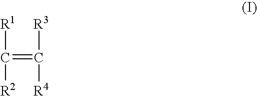
wherein R¹ to R⁴ are independently hydrogen, methyl, carboxylic acid group or CH₂COOH and wherein the carboxylic acid groups can be neutralized; (b) optionally, one or more structural units derived from at least one nonionic monomer having the general formula (II): 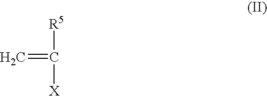
wherein R⁵ is hydrogen, C₁ to C₆ alkyl, or C₁ to C₆ hydroxyalkyl, and X is either aromatic (with R⁵ being hydrogen or methyl when X is aromatic) or X is of the general formula (III): 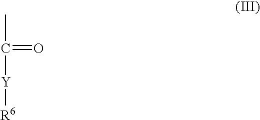
wherein R⁶ is (independently of R⁵) hydrogen, C₁ to C₆ alkyl, or C₁ to C₆ hydroxyalkyl, and Y is O or N; and at least one structural unit derived from at least one sulfonate monomer having the general formula (IV): 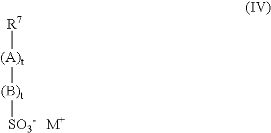
wherein R⁷ is a group comprising at least one sp² bond, A is O, N, P, S or an amido or ester linkage, B is a mono- or polycyclic aromatic group or an aliphatic group, each t is independently 0 or 1, and M³⁰ is a cation. In one aspect, R⁷ is a C₂ to C₆ alkene. In another aspect, R⁷ is ethane, butene or propene.
Sulfonated/Carboxylated Polymer with Low Sulfonate Functionality (SMPLSF)

The surface-treating compositions of the present invention may incorporate a cost-effective, water-soluble, sulfonated/carboxylated polymer with low sulfonate functionality, which is hereinafter referred to therein as an “SMPLSF.”

The at least one carboxylic acid functionality of a suitable SMPLSF may be present in any suitable amount. For example, the at least one carboxylic acid functionality may be present in any suitable amount less than or equal to about 0.01 mole %, or less than or equal to about 0.1 mole %, or less than or equal to about 1 mole %, or less than or equal to about 2 mole %, or less than or equal to about 5 mole %, or less than or equal to about 10 mole %, or less than or equal to about 20 mole %, or less than or equal to about 30 mole %, or less than or equal to about 40 mole %, or less than or equal to about 50 mole %, or less than or equal to about 55 mole %, or less than or equal to about 60 mole %, or less than or equal to about 65 mole %, or less than or equal to about 70 mole %, or less than or equal to about 75 mole %, or less than or equal to about 80 mole %, or less than or equal to about 85 mole %, or less than or equal to about 90 mole %, or less than or equal to about 95 mole %, or alternatively less than or equal to about 99.99 mole % of the total SMPLSF molar content.

The optional one or more nonionic functionality of a suitable SMPLSF may be present, if at all, in any suitable amount to provide hydrophobicity. For example, when present, the one or more nonionic functionality may be greater than or equal to about 0.01 mole %, or greater than or equal to about 0.1 mole %, or greater than or equal to about 1 mole %, or greater than or equal to about 2 mole %, or greater than or equal to about 3 mole %, or greater than or equal to about 4 mole %, or greater than or equal to about 5 mole %, or greater than or equal to about 10 mole %, or greater than or equal to about 20 mole %, or greater than or equal to about 30 mole %, or greater than or equal to about 40 mole %, or greater than or equal to about 50 mole %, or greater than or equal to about 60 mole %, or greater than or equal to about 70 mole %, or greater than or equal to about 80 mole %, or greater than or equal to about 90 mole %, or greater than or equal to about 95 mole %, or alternatively greater than or equal to about 99.98 mole % of the total SMPLSF molar content.

The at least one sulfonate functionality of a suitable SMPLSF may be present in any suitable amount less than 4 mole %. For example, the sulfonate functionality may be present at a level less than or equal to about 3.5 mole %, or less than or equal to about 3 mole %, or less than or equal to about 2.5 mole %, or less than or equal to about 2 mole %, or less than or equal to about 1.5 mole %, or less than or equal to about 1 mole %, or less than or equal to about 0.5 mole %, or equal to about 0.1 mole %, or alternatively less than or equal to about 0.01 mole % of the total SMPLSF molar content.

In one non-limiting embodiment, a suitable SMPLSF may comprise: (a) from about 0.01 mole % to less than 4 mole % of at least one sulfonate functionality; and (b) from about 99.99 mole % to about 96 mole % of a carboxylic acid functionality. In another non-limiting embodiment, this SMPLSF may be free of an ester and/or an amide functionality.

In another non-limiting embodiment, a suitable SMPLSF may comprise: (a) from about 0.01 mole % to about 95.99 mole % of at least one nonionic functionality; (b) from about 0.01 mole % to less than 4 mole % of at least one sulfonate functionality; and (c) from about 99.98 mole % to about 0.01 mole % of a carboxylic acid functionality. In another non-limiting embodiment, this SMPLSF may comprise an aromatic monomer, such as styrene.

In another non-limiting embodiment, the at least one carboxylic acid functionality can comprise one or more of the following: acrylic acid, maleic acid, itaconic acid, methacrylic acid, or ethoxylate esters of acrylic acids. In another non-limiting embodiment, the sulfonate functionality can comprise one or more of the following: sodium (meth) allyl sulfonate, vinyl sulfonate, sodium phenyl (meth) allyl ether sulfonate, or 2-acrylamido-methyl propane sulfonic acid. In another non-limiting embodiment, the optional one or more nonionic functionality can comprise one or more of the following: methyl (meth) acrylate, ethyl (meth) acrylate, t-butyl (meth) acrylate, methyl (meth) acrylamide, ethyl (meth) acrylamide, t-butyl (meth) acrylamide, styrene, or α-methyl styrene. In another non-limiting embodiment, a surface-treating composition may comprise an SMPLSF comprising styrene, having a molecular weight of less than or equal to about 100,000 Da.

Stability

In one non-limiting embodiment, the SMPLSF may be chemically stable in the surface-treating composition described herein in the presence of bleach and/or high pH. It is believed that stability of the SMPLSF is improved when an effective amount of one or more nonionic functionality is present, especially when the SMPLSF is free of an ester and/or amide functionality. This is not only useful for chlorine-containing and/or highly alkaline detergent products, but also in a chlorine-containing and/or highly alkaline wash water of a cleaning device (e.g. an automatic washing machine or dishwashing machine) where an ester and/or an amide functionality can be hydrolyzed and attacked in solution.

Hydrophobically Modified Polymer (HMP)

The surface-treating compositions of the present invention may also exhibit enhanced hard water anti-filming performance and improved product stability at a cheaper cost by incorporating a water-soluble, hydrophobically modified polymer comprising an effective amount of one or more nonionic monomers, at least one sulfonate-containing monomer, and at least one carboxylic acid-containing monomer, which is hereinafter referred to as an “HMP.”

The one or more nonionic functionality may be greater than or equal to about 0.01 mole %, or greater than or equal to about 0.1 mole %, or greater than or equal to about 1 mole %, or greater than or equal to about 2 mole %, or greater than or equal to about 3 mole %, or greater than or equal to about 4 mole %, or greater than or equal to about 5 mole %, or greater than or equal to about 10 mole %, or greater than or equal to about 20 mole %, or greater than or equal to about 30 mole %, or greater than or equal to about 40 mole %, or greater than or equal to about 50 mole %, or greater than or equal to about 60 mole %, or greater than or equal to about 70 mole %, or greater than or equal to about 80 mole %, or greater than or equal to about 90 mole %, or greater than or equal to about 95 mole %, or alternatively greater than or equal to about 99.98 mole % of the total HMP molar content.

The at least one carboxylic acid functionality and/or at least one sulfonate functionality of a suitable HMP may be present in any suitable amount. For example, any of these functionalities may be present in any suitable amount less than or equal to about 0.01 mole %, or less than or equal to about 0.02 mole %, or less than or equal to about 0.1 mole %, or less than or equal to about 1 mole %, or less than or equal to about 2 mole %, or less than or equal to about 5 mole %, or less than or equal to about 10 mole %, or less than or equal to about 20 mole %, or less than or equal to about 30 mole %, or less than or equal to about 40 mole %, or less than or equal to about 50 mole %, or less than or equal to about 55 mole %, or less than or equal to about 60 mole %, or less than or equal to about 65 mole %, or less than or equal to about 70 mole %, or less than or equal to about 75 mole %, or less than or equal to about 80 mole %, or less than or equal to about 85 mole %, or less than or equal to about 90 mole %, or less than or equal to about 95 mole %, or alternatively less than or equal to about 99.98 mole % of the total HMP molar content.

For example, in one non-limiting embodiment a suitable HMP may comprise: (a) from about 0.01 mole % to about 99.98 mole % of one or more nonionic functionality; (b) from about 0.01 mole % to less than 99.98 mole % of at least one sulfonate functionality; and (c) from about 99.98 mole % to about 0.01 mole % of a carboxylic acid functionality. In another non-limiting embodiment, a suitable water-soluble hydrophobically modified polymer may comprise: (a) from about 0.01 mole % to about 49.99 mole % of one or more nonionic functionality; (b) from about 0.01 mole % to about 49.99 mole % of a sulfonate-containing monomer; and (c) from about 0.02 mole % to about 99.98 mole % a carboxylic acid-containing monomer, by mole percent of the polymer.

The at least one nonionic functionality may be selected from the group consisting of methyl (meth) acrylate, ethyl (meth) acrylate, t-butyl (meth) acrylate, methyl (meth) acrylamide, ethyl (meth) acrylamide, t-butyl (meth) acrylamide, styrene, α-methyl styrene, and combinations thereof. In another non-limiting embodiment, the HMP may comprise one or more nonionic monomers that may be free of an ester and/or an amide functionality. A suitable example of one or more nonionic monomers that do not contain an ester and/or amide functionality includes, but is not limited to, an aromatic monomer (such as, styrene).

pH

Any suitable pH may be used herein. A suitable pH may be from about 1 to about 14, when measured at a 1% concentration in an aqueous solution unless otherwise noted. In certain non-limiting embodiments, the surface-treating composition may exhibit an alkaline pH in the range of from about 8 to about 14, or from about 9 to about 12.5, from about 9 to about 11.5, or alternatively from about 9 to about 10. These alkaline surface-treating compositions may comprise chlorine bleach. In certain other non-limiting embodiments, the surface-treating composition may exhibit an acidic pH in the range of from about 1 to about 6.5, or from about 1 to about 6, or from about 1 to about 5, or from about 1 to about 4, or from about 1 to about 3, or alternatively from about 1 to about 2.

In the case of automatic washing detergent compositions (such as, dishwashing detergents and heavy-duty or laundry detergents), mildly- to highly-alkaline compositions may be effectively used. However, in the case of hard surface cleaners (such as, medium-duty detergents and light-duty liquid detergents) less alkaline compositions may be desirable, especially when mildness to skin is a concern. In certain rinse aid compositions, a lower pH range may tend to reduce incompatibility and negative interaction with existing commercial product residues left in the dispenser reservoir of the automatic dishwashing machine prior to use.

Adjunct Ingredients

Any suitable adjunct ingredient in any suitable amount may be used in the surface-treating compositions described herein. Suitable adjunct ingredients include, but are not limited to: aesthetic agents, anti-filming agents, antiredopsition agents, anti-spotting agents, beads, binders, bleach activators, bleach catalysts, bleach stabilizing systems, bleaching agents, brighteners, buffering agents, builders, carriers, chelants, clay, color speckles, control release agents, corrosion inhibitors, dishcare agents, disinfectant, dispersant agents, dispersant polymers, draining promoting agents, drying agents, dyes, dye transfer inhibiting agents, enzymes, enzyme stabilizing systems, fillers, free radical inhibitors, fungicides, germicides, hydrotropes, opacifiers, perfumes, pH adjusting agents, pigments, processing aids, silicates, soil release agents, suds suppressors, surfactants, stabilizers, thickeners, zeolite, and mixtures thereof.

Suitable builders include, but are not limited to: alkali metals; ammonium and alkanolammonium salts of polyphosphates, alkali metal silicates, alkaline earth and alkali metal carbonates, nitrilotriacetic acids, polycarboxylates, (such as, citric acid, mellitic acid, succinic acid, oxydisuccinic acid, polymaleic acid, benzene 1,3,5-tricarboxylic acid, carboxymethyloxysuccinic acid, the water-soluble salts thereof), phosphates (e.g. sodium tripolyphosphate), and mixtures thereof. Suitable enzymes include, but are not limited to: proteases, amylases, cellulases, lipases, carbohydrases, bleaching enzymes, cutinases, esterases, and wild-type enzymes. Suitable surfactants include, but are not limited to: nonionic surfactants, anionic surfactants, cationic surfactants, ampholytic surfactants, zwitterionic surfactants, and mixtures thereof. Suitable bleaching agents include, but are not limited to: common inorganic/organic chlorine bleach (such as, sodium or potassium dichloroisocyanurate dihydrate, sodium hypochlorite, sodium hypochloride), hydrogen-peroxide releasing salt (such as, sodium perborate monohydrate (PB1), sodium perborate tetrahydrate (PB4)), sodium percarbonate, sodium peroxide, and mixtures thereof. Suitable bleach-modifying materials, include but are not limited to: hydrogen peroxide-source bleach activators (e.g. TAED), bleach catalysts (e.g. transition containing cobalt and manganese). Suitable carriers include, but are not limited to: water, low molecular weight organic solvents (such as, primary alcohols, secondary alcohols, monohyric alcohols, polyols, and mixtures thereof), and mixtures thereof.

Suitable acids include, but are not limited to: acetic acid, aspartic acid, benzoic acid, boric acid, bromic acid, citric acid, formic acid, gluconic acid, glutamic acid, hydrochloric acid, lactic acid, malic acid, nitric acid, sulfamic acid, sulfuric acid, tartaric acid, and mixtures thereof. Suitable corrosion inhibitors, include, but are not limited to: soluble metal salts, insoluble metal salts, and mixtures thereof. Suitable metal salts include, but are not limited to: aluminum, zinc (e.g. hydrozincite), magnesium, calcium, lanthanum, tin, gallium, strontium, titanium, and mixtures thereof). Suitable aesthetic agents include, but are not limited to: opacifiers, dyes, pigments, color speckles, beads, brighteners, and mixtures thereof.

In one non-limiting embodiment, the surface-treating composition may comprise a liquid, gel, or liquigel having a viscosity of from 50 cps to 2000 cps, or alternatively from 100 cps to 350 cps, measured with a Brookfield Viscometer, with a No. 18 spindle, at 20° C. These surface-treating compositions can also comprise any suitable solvent in any suitable amount (such as, an effective amount so as to reach the desired viscosity).

With the addition of suitable adjuncts, the surface-treating compositions described herein could be useful as automatic dishwashing detergent (ADD) compositions (e.g. builders, surfactants, enzymes, etc.), light-duty liquid dishwashing compositions, laundry compositions such as, compact and heavy-duty detergents (e.g. builders, surfactants, enzymes, etc.), rinse aid compositions (e.g. acid, nonionic low-foaming surfactants, carrier, etc.), and/or hard surface cleaning compositions (e.g. zwitterionic surfactants, germicide, etc.).

Suitable adjunct ingredients are disclosed in one or more of the following: U.S. Pat. Nos. 2,798,053; 2,954,347; 2,954,347; 3,308,067; 3,314,891; 3,455,839; 3,629,121; 3,723,322; 3,803,285; 3,929,107, 3,929,678; 3,933,672; 4,133,779; 4,141,841; 4,228,042; 4,239,660; 4,260,529; 4,265,779; 4,374,035; 4,379,080; 4,412,934; 4,483,779; 4,483,780; 4,536,314; 4,539,130; 4,565,647; 4,597,898; 4,606,838; 4,634,551; 4,652,392; 4,671,891; 4,681,592; 4,681,695; 4,681,704; 4,686,063; 4,702,857; 4,968,451; 5,332,528; 5,415,807; 5,435,935; 5,478,503; 5,500,154; 5,565,145; 5,670,475; 5,942,485; 5,952,278; 5,990,065; 6,004,922; 6,008,181; 6,020,303; 6,022,844; 6,069,122; 6,060,299; 6,060,443; 6,093,856; 6,130,194; 6,136,769; 6,143,707; 6,150,322; 6,153,577; 6,194,362; 6,221,825; 6,365,561; 6,372,708; 6,482,994; 6,528,477; 6,573,234; 6,589,926; 6,627,590; 6,645,925; and 6,656,900; WO Pat. Nos. 00/23548; 00/23549; 00/47708; 01/32816; 01/42408; 91/06637; 92/06162; 93/19038; 93/19146; 94/09099; 95/10591; 95/26393; 98/35002; 98/35003; 98/35004; 98/35005; 98/35006; 99/02663; 99/05082; 99/05084; 99/05241; 99/05242; 99/05243; 99/05244; 99/07656; 99/20726; and 99/27083; EP Pat. No. 130756; GB-A-1137741; Chemtech, March 1993, pp 30-33, and J. American Chemical Soc., 115, 10083-10090 (1993); and Kirk Othmer Encyclopedia of Chemical Technology, Third Edition, Volume 7, pages 430-447 (John Wiley & Sons, Inc., 1979).

In one non-limiting embodiment, the surface-treating composition may comprise from 0% to about 99.99%, or from about 0.01% to about 95%, or from about 0.01% to about 90%, or from about 0.01% to about 80%, or from about 0.01% to about 70%, or from about 0.01% to about 60%, or from about 0.01% to about 50%, or from about 0.01% to about 40%, or from about 0.01% to about 30%, or from about 0.01% to about 20%, or from about 0.01% to about 10%, or from about 0.01% to about 5%, or from about 0.01% to about 4%, or from about 0.01% to about 3%, or from about 0.01% to about 2%, or from about 0.01% to about 1%, or from about 0.01% to about 0.5%, or alternatively from about 0.01% to about 0.1%, by weight of the composition, of a suitable adjunct ingredient.

Product Form

The surface-treating composition can be provided in any suitable physical form. A suitable form may include, but is not limited to: solids; granules; powder; liquid; paste; cream; gel; liquigels, and combinations thereof. The surface-treating compositions used herein can comprise a unitized dose in one of the following forms: tablets; multi-phase tablets, gel pacs, capsules, multi-compartment capsules, water-soluble pouches, or multi-compartment pouches. The surface-treating composition can be dispensed from any suitable device. Suitable devices include, but are not limited to: wipe, hand mittens, boxes, baskets, bottles (e.g. pourable bottles, pump assisted bottles, squeeze bottles), multi-compartment bottles, jars, paste dispensers, and combinations thereof.

In the case of additive or multi-component products contained in single- and/or multi-compartment pouches, capsules, or bottles, it is not required that the adjunct ingredients nor the surface-treating compositions be in the same physical form. In one non-limiting embodiment, the surface-treating composition can provide in a multi-compartment, water-soluble pouch comprising both a solid and a liquid or gel component in a unit dose form. The presence of different forms may allow for a controlled release (e.g. delayed, sustained, triggered or slow release) of the surface-treating composition during treatment of a surface (e.g. during one or more wash and/or rinse cycles in an automatic dishwashing machine).

Water-soluble Pouch

Many of the surface-treating compositions described herein may demonstrate improved compatibility with partially hydrolysed, water-soluble polyvinyl alcohol (PVA) pouch materials of known construction and type. This is particularly surprising given that many well-known polar/or hydrolysed bonding solvent materials (for example the organoamines) in themselves have low compatibility with PVA materials and present serious issues for product stability.

Method of Use/Composition of Matter

Any suitable domestic, institutional, industrial, and/or commercial method of treating a surface may be used in herein. In the methods described herein, any suitable surface-treating composition may be used, alone or in combination with a composition of matter (such as the wash and/or rinse water), and/or as part of an article of manufacture comprising a kit having a composition comprising an effective amount of a suitable sulfonated/carboxylated polymer. Any suitable surface may be treated with the sulfonated/carboxylated polymer described herein.

In one non-limiting embodiment, the method may comprise the step of contacting a surface with a surface-treating composition comprising the sulfonated/carboxylated polymer described herein. In another non-limiting embodiment, the method may comprise the step of contacting tableware, especially glass and plastic, in a cleaning device (e.g. an automatic dishwashing machine) with a composition of matter comprising a wash and/or rinse water having a concentration from about 1 ppm to about 10,000 ppm by concentration, of the above described surface-treating composition, as delivered to the tableware surface via the cleaning device. In other non-limiting embodiments, the method may comprise the step of contacting laundry with a composition of mattei comprising a wash and/or rinse water having a concentration from about 1 ppm to about 10,000 ppm by concentration, of the above-described surface-treating composition, as delivered to the laundry surface via a cleaning device (e.g. an automatic washing machine). In other non-limiting embodiments, the method may comprise the step of contacting a car surface with a composition of matter comprising a wash and/or rinse water having a concentration from about 1 ppm to about 10,000 ppm by concentration, of the above-described surface-treating composition, as delivered to the car surface via a cleaning device (e.g. an automatic car wash or hand-held pressure washer).

### EXAMPLES

### EXAMPLE 1

A surface-treating composition of the present invention may incorporate any suitable sulfonated/carboxylated polymer described herein. To prepare a suitable sulfonated/carboxylated polymer comprising acrylic acid (‘AA’), styrene, sodium methallylsulfonate (‘SMS’) and sodium phenylmethallylether (‘SPME’) in the mole ratio 89:10:0.57:0.43, an initial charge of 150 g deionized water, 120 g isopropyl alcohol, 3.2 grams SMS and 4.0 grams SPME was added to a 1-liter glass reactor fitted with a lid and having inlet ports for an agitator, water cooled condenser and for the addition of monomer and initiator solutions. The reactor contents were heated to reflux (approximately 85° C.). At reflux, continuous additions of 226 g of acrylic acid and 36.1 g of styrene were added concurrently to the reactor with stirring over a period of 3 hours. During the same time period and for 30 additional minutes, an initiator solution of 13.3 grams sodium persulfate dissolved in 80 grams water was also added. At the end of the initiator addition, a 50% aqueous sodium hydroxide solution (251 g) along with 100 grams water was added. The alcohol co-solvent (approximately 200 grams) was removed from the polymer solution by azeotropic distillation.

The surface-treating compositions described herein can be suitably prepared and packaged by any process chosen by the formulator, non-limiting examples of which are described in U.S. Pat. No. 4,005,024 issued Jan. 25, 1977; U.S. Pat. No. 4,237,155 issued Dec. 2, 1980; U.S. Pat. No. 5,378,409 issued Jan. 3, 1995; U.S. Pat. No. 5,486,303 issued Jan. 23, 1996; U.S. Pat. No. 5,489,392 issued Feb. 6, 1996; U.S. Pat. No. 5,516,448 issued May 14, 1996; U.S. Pat. No. 5,565,422 issued Oct. 15, 1996; U.S. Pat. No. 5,569,645 issued Oct. 29, 1996; U.S. Pat. No. 5,574,005 issued Nov. 12, 1996; U.S. Pat. No. 5,599,400 issued Feb. 4, 1997; U.S. Pat. No. 5,599,786 issued Feb. 4, 1997; U.S. Pat. No. 5,691,297 issued Nov. 11, 1997; U.S. Pat. No. 5,698,505 issued Dec. 16, 1997; U.S. Pat. No. 5,703,034 issued Dec. 30, 1997; U.S. Pat. No. 5,768,918 issued Jun. 23, 1998; U.S. Pat. No. 5,891,836 issued Apr. 6, 1999; U.S. Pat. No. 5,952,278 issued Sep. 14, 1999; U.S. Pat. No. 5,952,278 issued Sep. 14, 1999; U.S. Pat. No. 5,968,539 issued Oct. 19, 1999; U.S. Pat. No. 5,990,065 issued Nov. 23, 1999; U.S. Pat. No. 6,069,122 issued May 30, 2000; U.S. Pat. No. 6,147,037 issued Nov. 14, 2000; U.S. Pat. No. 6,156,710 issued Dec. 5, 2000; U.S. Pat. No. 6,162,778 issued Dec. 19, 2000; U.S. Pat. No. 6,180,583 issued Jan. 30, 2001; U.S. Pat. No. 6,183,757 issued Feb. 6, 2001; U.S. Pat. No. 6,190,675 issued Feb. 20, 2001; U.S. Pat. No. 6,204,234 issued Mar. 20, 2001; U.S. Pat. No. 6,214,363 issued Apr. 10, 2001; U.S. Pat. No. 6,251,845 issued Jun. 26, 2001; U.S. Pat. No. 6,274,539 issued Aug. 14, 2001; U.S. Pat. No. 6,281,181 issued Aug. 28, 2001; U.S. Pat. No. 6,365,561 issued Apr. 2, 2002; U.S. Pat. No. 6,372,708 issued Apr. 16, 2002; U.S. Pat. No. 6,444,629 issued Sep. 3, 2002; U.S. Pat. No. 6,451,333 issued Sep. 17, 2002; U.S. Pat. No. 6,482,994 issued Nov. 19, 2002; U.S. Pat. No. 6,528,477 issued Mar. 4, 2003; U.S. Pat. No. 6,559,116 issued May 6, 2003; U.S. Pat. No. 6,573,234 issued Jun. 3, 2003; U.S. Pat. No. 6,589,926 issued Jul. 8, 2003; U.S. Pat. No. 6,627,590 issued Sep. 30, 2003; U.S. Pat. No. 6,627,590 issued Sep. 30, 2003; U.S. Pat. No. 6,630,440 issued Oct. 7, 2003; U.S. Pat. No. 6,645,925 issued Nov. 11, 2003; and U.S. Pat. No. 6,656,900 issued Dec. 2, 2003; U.S. Pat. Appl. Nos. 20030228998 to Dupont published December 2003; U.S. 20010026792 to Farrell et al. published October 2001; 20010031714 to Gassenmeier et al. published October 2001; 20020004472 to Holderbaum et al. published January 2002; 20020004473 to Busch et al. published January 2002; 20020013232 to Kinoshita et al. published January 2002; 20020013242 to Baillely et al. published January 2002; 20020013243 to Brown published March 2002; 20020028756 to Carter et al. published March 2002; 20020033004 to Edwards et al. published March 2002; 20020045559 to Forth et al. published April 2002; 20020055449 to Porta et al. published May 2002; 20020094942 to Danneels et al. published July 2002; 20020119903 to Lant et al. published August 2002; 20020123443 to Bennie et al. published September 2002; 20020123444 to Fisher et al. published September 2002; 20020137648 to Sharma et al. published September 2002; 20020166779 to Etesse et al. published November 2002; 20020169092 to Catlin et al. published November 2002; 20020169095 to Forth et al. November 2002; and 20020198125 to Jones published December 2002.

Tables I-III provide non-limiting product formulations of suitable ADD compositions. Table IV provides non-limiting product formulations of suitable rinse aid compositions. Tables V and VI provide non-limiting product formulations of suitable laundry detergents. Table VII provides non-limiting product formulations of suitable hard surface cleaning compositions. Table VIII provides non-limiting product formulations of suitable light-duty liquid detergent compositions. Tables IX and X provide the chemical composition and name of some non-limiting examples of sulfonated/carboxylated polymers described herein.

TABLE I
Liquid/Gel ADD Composition

| | EXAMPLES | | | | | |
|---|---|---|---|---|---|---|
| INGREDIENTS | 2 | 3 | 4 | 5 | 6 | 7 |
| STPP/SKTP/KTPP | 17.5 | 17.5 | 17.5 | 17.5 | 22.0 | 22.0 |
| Polymer¹ | 0.5 | 1.0 | 2.0 | 4.0 | 0.5 | 2.0 |
| Sodium hydroxide | 1.9 | 1.9 | 1.9 | 1.9 | — | — |
| Potassium hydroxide | 3.9 | 3.9 | 3.9 | 3.9 | 5.8 | 5.8 |
| Sodium silicate | 7.0 | 7.0 | 7.0 | 7.0 | — | — |
| H2SO4 | — | — | — | — | 3.9 | 3.9 |
| Thickener | 1.0 | 1.0 | 1.0 | 1.0 | 1.2 | 1.2 |
| Sodium hypochlorite | 1.2 | 1.2 | 1.2 | 1.2 | — | — |
| Nonionic surfactant | — | — | — | — | 1.0 | 1.0 |
| Protease enzyme | — | — | — | — | 0.6 | 0.6 |
| Amylase enzyme | — | — | — | — | 0.2 | 0.2 |
| Enzyme stabilizing agents | — | — | — | — | 3.5 | 3.5 |
| Water and minors² | Balance | Balance | Balance | Balance | Balance | Balance |
| pH (1% Solution) | 11.7 | 11.7 | 11.7 | 11.7 | 9 | 9 |

¹Hydrophobically modified, sulfonated/carboyxlated polymer “E” with 80.9 mole % AA, 0 mole % MA, 18 mole % STY, 0.62% SMS and 0.5 mole % SPME.
²Balance to 100% can, for example, include dyes, perfumes, speckles, corrosion inhibitor, dishcare agent, fillers, solvents, polymers, and additional water.

TABLE II
Granular Or Powder ADD Composition

| | EXAMPLES | | | | | | |
|---|---|---|---|---|---|---|---|
| INGREDIENTS | 8 | 9 | 10 | 11 | 12 | 13 | 14 |
| STPP/SKTP/KTPP | 20.0 | 20.0 | 23.0 | 23.0 | 23.0 | 28.0 | — |
| Sodium citrate | — | — | — | — | — | — | 25 |
| Hydrozincite | — | 0.05 | 0.10 | 0.15 | 0.5 | 0.1 | 0.1 |
| Polymer¹ | 1.0 | 1.0 | 1.0 | 1.0 | 1.0 | 1.0 | 1.0 |
| Sodium carbonate | 30.0 | 30.0 | 30.0 | 30.0 | 30.0 | 30.0 | 30.0 |
| Sodium silicate | 5.5 | 5.5 | 5.5 | 5.5 | 5.5 | 5.5 | 5.5 |
| Surfactant | 0.9 | 0.9 | 0.9 | 0.9 | 0.9 | 1.8 | 0.9 |
| Polymer | — | — | — | — | — | 3.3 | — |
| Dispersant² | | | | | | | |
| Sodium perborate | 4.3 | 4.3 | 4.3 | 4.3 | 4.3 | 4.3 | 4.3 |
| Bleach catalyst³ | 0.004 | 0.004 | 0.004 | 0.004 | 0.004 | 0.004 | 0.004 |
| Protease enzyme | 0.6 | 0.6 | 0.6 | 0.6 | 0.6 | 1.0 | 0.25 |
| Amylase enzyme | 0.2 | 0.2 | 0.2 | 0.2 | 0.2 | 0.2 | 0.13 |
| Water and minors⁴ | Balance | Balance | Balance | Balance | Balance | Balance | Balance |
| pH (1% Solution) | 10 | 10 | 10 | 10 | 10 | 10 | 10 |

¹Hydrophobically modified, sulfonated/carboyxlated polymer “E” with 80.9 mole % AA, 0 mole % MA, 18 mole % STY, 0.62% SMS and 0.5 mole % SPME.
²PEI 189 E15-18 according to U.S. Pat. No. 4,597,898 Vander Meer, issued Jul. 1, 1986.
³5,12-dimethyl-1,5,8,12-tetraaza-bicyclo[6.6.2]hexadecanemanganese (II) chloride.
⁴Balance to 100% can, for example, include dyes, perfumes, speckles, corrosion inhibitor, dishcare agent, fillers, solvents, and other polymers.

TABLE III
ADD Compositions in Water-Soluble Pouches⁴

| | EXAMPLES | | | | |
|---|---|---|---|---|---|
| INGREDIENTS | 15 | 16 | 17 | 18 | 19 |
| STPP/SKTP/KTPP | 33.0 | 33.0 | 33.0 | 33.4 | 30.7 |
| Sodium citrate | — | — | — | — | 33.6 |
| Polymer¹ | 1.0 | 1.0 | 1.0 | 1.0 | 1.0 |
| Sodium carbonate | 19.0 | 19.0 | 28.0 | 26.0 | — |
| Sodium silicate | 7.8 | 7.8 | 4.2 | 4.3 | — |
| Surfactant | 3.2 | 3.2 | 6.5 | 2.3 | 0.5 |
| Dispersant polymer | — | — | 4.3 | — | — |
| NaDCC/sodium | — | — | — | 1.1 | — |
| hypochloride | | | | | |
| Sodium perborate | 12.8 | 12.8 | 9.3 | — | — |
| Bleach catalyst² | 0.013 | 0.013 | 1.4 | — | — |
| Protease enzyme | 2.2 | 2.2 | 0.3 | — | 1.3 |
| Amylase enzyme | 1.7 | 1.7 | 0.9 | — | 0.2 |
| Water and minors³ | Balance | Balance | Balance | Balance | Balance |
| pH (1% Solution) | 10 | 10 | 10 | 10 | 10 |

¹Hydrophobically modified, sulfonated/carboyxlated polymer “E” with 80.9 mole % AA, 0 mole % MA, 18 mole % STY, 0.62% SMS and 0.5 mole % SPME.
²5,12-dimethyl-1,5,8,12-tetraaza-bicyclo[6.6.2]hexadecanemanganese (II) chloride.
³Balance to 100% can, for example, include dyes, perfumes, speckles, corrosion inhibitor, dishcare agent, fillers, solvents, polymers, and additional water.
⁴Single-compartment or multiple-compartmented water-soluble pouches comprised of partially hydrolyzed, water-soluble polyvinyl alcohol.

TABLE IV
Rinse Aid Composition

| | EXAMPLES | | | | |
|---|---|---|---|---|---|
| INGREDIENTS | 20 | 21 | 22 | 23 | 24 |
| Polymer¹ | 1.0 | 4.0 | 5.0 | 5.0 | 10.0 |
| Nonionic Surfactant | 35.0 | 35.0 | 35.0 | 35.0 | 20.0 |
| Acid | — | 1.2 | 1.56 | — | — |
| Chelating Agent | — | — | — | — | 20.0 |
| Polymer Dispersant² | — | — | 4.0 | — | — |
| Perfume | 0.12 | 0.12 | 0.12 | 0.12 | — |
| Water and minors³ | Balance | Balance | Balance | Balance | Balance |
| pH (1% Solution) | 6.5 | 2.6 | 2.6 | 2.8 | 2.8 |

¹Hydrophobically modified, sulfonated/carboyxlated polymer “E” with 80.9 mole % AA, 0 mole % MA, 18 mole % STY, 0.62% SMS and 0.5 mole % SPME.
²PEI 189 E15-18 according to U.S. Pat. No. 4,597,898 Vander Meer, issued Jul. 1, 1986.
³Balance to 100% can, for example, include dyes, perfumes, speckles, corrosion inhibitor, dishcare agent, hydrotropes, solvents, polymers, and additional water.

TABLE V
Granular Heavy-Duty Laundry Detergent Composition

| | EXAMPLES | | | | | | | |
|---|---|---|---|---|---|---|---|---|
| INGREDIENTS | 25 | 26 | 27 | 28 | 29 | 30 | 31 | 32 |
| Anionic | 22 | 22 | 18 | 20 | 20 | 10.6 | 10.6 | 28 |
| surfactant | | | | | | | | |
| Nonionic | 1.5 | 1.5 | 0.5 | 1.1 | 1.1 | 9.4 | 9.4 | 3.3 |
| surfactant | | | | | | | | |
| Cationic | — | — | — | 0.7 | 0.7 | — | — | 0.5 |
| surfactant | | | | | | | | |
| Zeolite | 28 | 28 | 25 | — | — | 24 | 24 | 11 |
| Phosphate | — | — | — | 25 | 25 | — | — | — |
| Silicate | — | — | — | — | — | 8.5 | 8.5 | 7.5 |
| Sodium | 27 | 27 | 19 | 14 | 14 | 8.9 | 8.9 | 15 |
| carbonate/ | | | | | | | | |
| bicarbonate | | | | | | | | |
| Sodium sulfate | 5.4 | 5.4 | 11 | 15 | 15 | 11 | 11 | 3.5 |
| Sodium silicate | 0.6 | 0.6 | 1.1 | 10 | 10 | — | — | 12 |
| Enzymes | 0.4 | 0.4 | 0.4 | 1.6 | 1.6 | 1.5 | 1.5 | 0.2 |
| Polyamine | 4.3 | 4.3 | 6.5 | 1.9 | 1.9 | 5.0 | 5.0 | 0.7 |
| Polymer¹ | 1.0 | 1.0 | 1.0 | 1.0 | — | — | — | — |
| Polymer² | — | — | — | — | 1.0 | 1.0 | 1.0 | 1.0 |
| Chelants | — | — | 0.5 | — | 1.0 | 0.5 | 0.5 | — |
| Brighteners | 0.2 | 0.2 | 0.3 | 0.2 | 0.2 | — | — | 0.3 |
| Sodium | — | 1.0 | — | — | — | — | — | — |
| perborate | | | | | | | | |
| Sodium | — | — | — | — | 1.0 | 1.0 | 1.0 | 1.0 |
| Hypochlorite | | | | | | | | |
| Sodium | 1.0 | — | — | — | — | — | — | — |
| percarbonate | | | | | | | | |
| Photobleach | — | — | — | 0.005 | — | — | — | — |
| Suds | 0.2 | 0.2 | 6.4 | — | — | 0.4 | 0.4 | 0.2 |
| suppressors | | | | | | | | |
| Bleach catalyst³ | 0.5 | 1.0 | 0.5 | 0.5 | — | — | — | — |
| Water and | Balance | Balance | Balance | Balance | Balance | Balance | Balance | Balance |
| minors⁴ | | | | | | | | |
| ¹Sulfonated/carboyxlated polymer “B” with 78 mole % AA, 25 mole % MA, 1 mole % SMS, 1% SPME and 0 mole % STY. | | | | | | | | |
| ²Hydrophobically modified, sulfonated/carboyxlated polymer “E” with 80.9 mole % AA, 0 mole % MA, 18 mole % STY, 0.62% SMS and 0.5 mole % SPME. | | | | | | | | |
| ³5,12-dimethyl-1,5,8,12-tetraaza-bicyclo[6.6.2]hexadecanemanganese (II) chloride. | | | | | | | | |
| ⁴Balance to 100% can, for example, include minors like bleach catalysts inter alia, 1,5-bis(hydroxymethylene)-3,7-dimethyl-2,4-bis(2-pyridyl)-3,7-diazabicyclo[3.3.1]-nonan-9-ol manganese(II) dichloride 1/2H2O, dispersants, inter alia, PEI 189 E15-18 | | | | | | | | |
| # according to U.S. Pat. No. 4,597,898 Vander Meer, issued Jul. 1, 1986, or PEI 1800 E7 according to U.S. Pat. No. 5,565,145 Watson et al., issued Oct. 15, 1996, optical brightener, perfume, suds suppresser, soil release agents, inter alia, according to U.S. Pat. No. 4,702,857 Gosselink, issued Oct. 27, 1987, or U.S. Pat. No. 4,968,451, Scheibel et al., issued Nov. 6, 1990, chelating agents, dye transfer inhibiting agents, additional water, and fillers, including CaCO3, talc, silicates, etc | | | | | | | | |

TABLE VI
Heavy-Duty Liquid Laundry Detergent Composition

| | EXAMPLES | | | | | |
|---|---|---|---|---|---|---|
| INGREDIENTS | 33 | 34 | 35 | 36 | 37 | 38 |
| C14-C15 alkyl E1.0 sulfate | 22.5 | 22.5 | 22.5 | 22.5 | — | — |
| Sodium C14-C15 alcohol sulfate | — | — | — | — | 4.5 | 11.2 |
| Sodium C14-C15 alcohol | — | — | — | — | 0.5 | 1.0 |
| ethoxylate (6.5) | | | | | | |
| Linear alkyl benzene sulfonate | 3.0 | 3.0 | 3.0 | 3.0 | — | — |
| Sodium C11-C13 | — | — | — | — | 10.4 | 11.1 |
| alkylbenzene sulfonate | | | | | | |
| C10 amidopropyl DMA | 1.5 | 1.5 | 1.5 | 1.5 | — | — |
| C12-C14 alkyl E7.0 | 3.0 | 3.0 | 3.0 | 3.0 | — | — |
| Citric Acid | 2.5 | 2.5 | 2.5 | 2.5 | — | — |
| C12-C18 alkyl fatty acid | 3.5 | 3.5 | 3.5 | 3.5 | — | — |
| Sodium carbonate | — | — | — | — | 25.2 | 16.1 |
| Sodium silicate (1:6 ratio | — | — | — | — | 2.1 | 2.6 |
| NaO/SiO₂)(46%) | | | | | | |
| Sodium sulfate | — | — | — | — | 8.2 | 15.0 |
| Tallow fatty acid | — | — | — | — | — | 1.1 |
| Rapeseed fatty acid | 5.0 | 5.0 | 5.0 | 5.0 | | |
| Zeolite A, hydrate | — | — | — | — | 21.3 | 28.0 |
| (0.1-10 micron size) | | | | | | |
| Protease | 0.8 | 1.57 | 1.57 | 1.57 | — | — |
| Amylase | 0.055 | 0.088 | 0.088 | 0.088 | — | — |
| Cellulase | 0.188 | 0.055 | 0.055 | 0.055 | — | — |
| Lipolase | 0.06 | — | — | — | — | — |
| mannanase | 0.007 | 0.0033 | 0.0033 | 0.0033 | — | — |
| Sodium metaborate | 2.0 | 2.5 | 2.5 | 2.5 | — | — |
| Ca formate/CaCl2 | 0.02 | 0.10 | 0.10 | 0.10 | — | — |
| Polyamine | 1.0 | 2.0 | 2.0 | 3.5 | — | — |
| Polymer¹ | 1.0 | 1.0 | 1.0 | 1.0 | 1.0 | 1.0 |
| Sodium perborate | — | — | — | — | 5.0 | — |
| Bleach activator² | — | — | — | — | 5.9 | — |
| Bleach catalyst³ | 0.035 | 0.034 | 0.034 | 0.034 | — | — |
| Hydrophobic dispersant⁴ | 0.65 | 0.76 | 0.76 | 0.76 | | |
| Poly(ethyleneglycol), MW | — | — | — | — | 1.0 | 1.1 |
| ˜4000 (50%) | | | | | | |
| Soil release agent⁵ | — | — | — | — | 0.10 | 0.10 |
| Soil release agent⁶ | 0.147 | — | — | — | — | — |
| Soil release agent⁷ | — | 0.10 | 0.10 | 0.10 | — | — |
| Suds suppresser | 0.60 | 0.60 | 0.60 | 0.60 | 0.60 | 0.60 |
| Water and minors⁸ | Balance | Balance | Balance | Balance | Balance | Balance |
| pH (1% Solution) | 9 | 9.8 | 10 | 10.5 | 10.5 | 11.5 |

¹Hydrophobically modified, sulfonated/carboyxlated polymer “E” with 80.9 mole % AA, 0 mole % MA, 18 mole % STY, 0.62% SMS and 0.5 mole % SPME.
²Nonyl ester of sodium p-hydroxybenzene-sulfonate.
³1,5-bis(hydroxymethylene)-3,7-dimethyl-2,4-bis(2-pyridyl)-3,7-diazabicyclo[3.3.1]-nonan-9-ol manganese(II) dichloride ½H2O.
⁴PEI 189 E15-18 according to U.S. Pat. No. 4,597,898 Vander Meer, issued Jul. 1, 1986.
⁵Soil release agent according to U.S. Pat. No. 5,415,807 Gosselink et al., issued May 16, 1995
⁶Soil release agent according to U.S. Pat. No. 4,702,857 Gosselink, issued Oct. 27, 1987.
⁷Soil release agent according to U.S. Pat. No. 4,968,451, Scheibel et al., issued Nov. 6, 1990.
⁸Balance to 100% can, for example, include minors like optical brightener, perfume, polymers, soil dispersant, chelating agents, dye transfer inhibiting agents, additional water, and fillers, including CaCO3, etc.

TABLE VII
Hard Surface Cleaning Composition

| | EXAMPLES | | | | | | |
|---|---|---|---|---|---|---|---|
| INGREDIENTS | 39 | 40 | 41 | 42 | 43 | 44 | 45 |
| Polymer¹ | 0.05 | — | — | 0.5 | — | — | 0.5 |
| Polymer² | — | 1.0 | — | — | 0.5 | — | 0.5 |
| Polymer³ | — | — | 0.10 | — | — | 1.0 | 1.0 |
| C9-11 alcohol | — | 3.0 | — | — | — | — | — |
| ethoxylate (5.0) | | | | | | | |
| C12-14 alcohol | — | 2.0 | — | — | — | — | — |
| ethoxylate (5.0) | | | | | | | |
| C12-14 alcohol | — | — | 0.05 | — | — | — | — |
| ethoxylate (21) | | | | | | | |
| C12-14 Cocamido | — | — | 0.22 | — | — | — | — |
| propyl sulfobetaine | | | | | | | |
| C12-14 | — | — | — | 0.20 | — | — | — |
| Cocamidopropyl | | | | | | | |
| betaine | | | | | | | |
| C10 Alkyl | 0.05 | — | — | — | — | 10.0 | 10.0 |
| Polyglucoside | | | | | | | |
| Sodium C10 Sulfate | — | — | — | — | 3.0 | — | — |
| Linear Alkyl | — | 0.25 | — | — | — | — | — |
| Benzene Sulfonate | | | | | | | |
| Ethanolamine | — | — | — | 0.50 | — | — | — |
| Sodium carbonate | | 0.5 | — | — | — | — | — |
| 2-amino-2-methyl-1- | 0.01 | — | — | 0.5 | — | — | — |
| propanol | | | | | | | |
| Propylene glycol n- | 1.0 | — | 2.2 | 2.0 | — | — | — |
| butyl ether | | | | | | | |
| Dipropylene glycol | — | — | — | — | 4.0 | — | — |
| n-butyl ether | | | | | | | |
| Ethanol | 3.0 | — | 8.0 | 3.0 | — | — | — |
| Didecyl dimethyl | — | — | — | 0.3 | | | |
| ammonium chloride | | | | | | | |
| Xanthan Gum | — | — | — | — | 0.05 | | |
| Modified | 0.2 | — | — | — | — | — | — |
| Polyethylene imine⁵ | | | | | | | |
| Polyzwitterionic | — | — | — | — | — | 3.0 | 3.0 |
| polymer⁶ | | | | | | | |
| Poly(hexamethylene) | — | — | 0.30 | 0.10 | — | — | — |
| biguanide | | | | | | | |
| Citric Acid (50%) | — | — | 0.50 | — | 4.5 | — | — |
| Tartaric acid | — | — | — | 0.25 | — | — | — |
| NaOH (50%) | — | — | — | — | 0.6 | — | — |
| Water and minors⁷ | Balance | Balance | Balance | Balance | Balance | Balance | Balance |
| pH (10% Solution) | 9.0 | 10.5 | 3.0 | 11.0 | 3.0 | 5.0 | 5.0 |

¹Hydrophobically-modified, sulfonated/carboyxlated polymer “E” with 80.9 mole % AA, 0 mole % MA, 18 mole % STY, 0.62% SMS and 0.5 mole % SPME.
²Sulfonated/carboyxlated polymer “B” with 78 mole % AA, 25 mole % MA, 1 mole % SMS, 1% SPME and 0 mole % STY.
³Sulfonated/carboyxlated polymer “C” with 78 mole % AA, 20 mole % MA, 1 mole % SMS, 1% SPME and 0 mole % STY.
⁴A mixture of N-alkyl dimethyl ethylbenzyl ammonium chloride and N-dimethyl benzyl alkyl ammonium chloride may be provided.
⁵Lupasol SK from BASF Corporation.
⁶Mirapol HSC-300 from Rhodia Corporation.
⁷Balance to 100% can, for example, include dyes, perfumes, speckles, corrosion inhibitor, hydrotropes, solvents, polymers, and additional water.

TABLE VIII
Light-duty Liquid Detergent Composition

| | EXAMPLES | | | | | | |
|---|---|---|---|---|---|---|---|
| INGREDIENTS | 46 | 47 | 48 | 49 | 50 | 51 | 52 |
| Polymer¹ | 1.0 | 1.0 | 1.0 | — | — | — | — |
| Polymer² | — | — | — | — | 1.0 | — | 1.0 |
| Polymer³ | — | — | — | 1.0 | — | 1.0 | — |
| Poly(dimethylamino- | 0.2 | — | — | 0.2 | 0.2 | 0.2 | 0.2 |
| methacrylate) | | | | | | | |
| Suds Boosting | | | | | | | |
| Polymer | | | | | | | |
| Bis(aminomethyl) | 0.5 | 0.5 | 0.5 | 0.5 | 0.5 | 0.5 | 0.5 |
| cyclohexane | | | | | | | |
| diamine | | | | | | | |
| Alkyl Ethoxy | 26.5 | 26.5 | 26.5 | 26.5 | 26.5 | 26.5 | 26.5 |
| (0.6) Sulfate | | | | | | | |
| C9E11 Nonionic | 3.0 | 3.0 | 3.0 | 3.0 | 3.0 | 3.0 | 3.0 |
| (Neodol 9-11) | | | | | | | |
| C12 Dimethyl | 6.0 | 6.0 | 6.0 | 6.0 | 6.0 | 6.0 | 6.0 |
| Amine Oxide | | | | | | | |
| Ethanol | 4.0 | 4.0 | 4.0 | 4.0 | 4.0 | 4.0 | 4.0 |
| Sodium Cumene | 4.0 | 4.0 | 4.5 | 4.0 | — | 4.0 | — |
| Sulfonate | | | | | | | |
| Amylase | 0.2 | 0.2 | — | 0.2 | — | 0.2 | — |
| Enzyme | | | | | | | |
| Protease Enzyme | 0.5 | 0.5 | — | 0.5 | 0.5 | — | 0.5 |
| Water and | Balance | Balance | Balance | Balance | Balance | Balance | Balance |
| minors⁴ | | | | | | | |
| pH (10% | 9.0 | 9.0 | 9.0 | 9.0 | 9.0 | 9.0 | 9.0 |
| Solution) | | | | | | | |

¹Hydrophobically modified, sulfonated/carboyxlated polymer “E” with 80.9 mole % AA, 0 mole % MA, 18 mole % STY, 0.62% SMS and 0.5 mole % SPME.
²Sulfonated/carboyxlated polymer “B” with 78 mole % AA, 25 mole % MA, 1 mole % SMS, 1% SPME and 0 mole % STY.
³Sulfonated/carboyxlated polymer “C” with 78 mole % AA, 20 mole % MA, 1 mole % SMS, 1% SPME and 0 mole % STY.
⁴Balance to 100% can, for example, include dyes, perfumes, speckles, corrosion inhibitor, and additional water.

TABLE IX
Chemical Composition of the Sulfonated/carboxylated Polymers

| | | MONOMERS (% MOLE) | | | | | |
|---|---|---|---|---|---|---|---|
| Polymer | MW | AA | MMA | STY | SMS | SPME | MAA |
| Polyacrylate¹ | <10 | 100 | 0 | 0 | 0 | 0 | 0 |
| A | 20.5 | 68 | 30 | 0 | 1 | 1 | 0 |
| B | 20.4 | 73 | 25 | 0 | 1 | 1 | 0 |
| C | 20.3 | 78 | 20 | 0 | 1 | 1 | 0 |
| D | 27.3 | 80 | 0 | 18 | 1 | 1 | 0 |
| E | 49.1 | 80.88 | 0 | 18 | 0.62 | 0.5 | 0 |
| F | 20.2 | 89 | 0 | 10 | 0.57 | 0.45 | 0 |
| G | 13.7 | 94 | 0 | 5 | 0.57 | 0.45 | 0 |

¹An unmodified polyacrylate having a molecular weight less than about 10 kDa.

TABLE X
Key To Acronyms

| | |
|---|---|
| MW | Weight average molecular weight. |
| AA | Acrylic acid |
| AMPS | 2-acrylamido-2methyl-propansulphonic |
| SMS | Sodium methallyl sulfonate |
| MAA | Methacrylic acid |
| MMA | Methyl methyacrylate |
| SPME | Sulfophenylmethallylether |
| STY | Styrene |

The disclosure of all patents, patent applications (and any patents which issue thereon, as well as any corresponding published foreign patent applications), and publications mentioned throughout this description are hereby incorporated by reference herein. It is expressly not admitted, however, that any of the documents incorporated by reference herein teach or disclose the present invention.

It should be understood that every maximum numerical limitation given throughout this specification would include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

While particular embodiments of the subject invention have been described, it will be obvious to those skilled in the art that various changes and modifications of the subject invention can be made without departing from the spirit and scope of the invention. It will be clear to those skilled in the art that various changes and modifications may be made without departing from the scope of the invention and the invention is not to be considered limited to the embodiments and examples that are described in the specification.

1. A method of treating a surface, said method comprising a step of contacting said surface with a surface-treating composition comprising:
a) an effective amount of a water-soluble, sulfonated/carboxylated polymer having a molar content, said polymer comprising:
(i) at least one carboxylic acid functionality;
(ii) optionally, one or more nonionic functionality; and
(iii) at least one sulfonate functionality, wherein said sulfonate functionality is less than 4 mole % of the molar content of said polymer; and
b) at least one adjunct ingredient.

2. The method according to claim 1 wherein said at least one carboxylic acid functionality comprises at least one structural unit derived from at least one carboxylic monomer having the general formula (I): 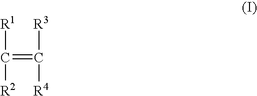
wherein R1 to R4 are independently hydrogen, methyl, carboxylic acid group or CH2COOH and wherein said carboxylic acid groups can be neutralized.

3. The method according to claim 1 wherein said one or more nonionic functionality comprises at least one structural unit derived from at least one nonionic monomer having the general formula (II): 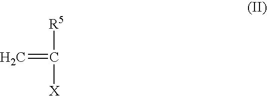
wherein R⁵ is hydrogen, C₁ to C₆ alkyl, or C₁ to C₆ hydroxyalkyl, and X is either aromatic (with R⁵ being hydrogen or methyl when X is aromatic) or X is of the general formula (III): 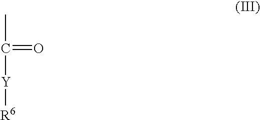
wherein R⁶ is (independently of R⁵) hydrogen, C₁ to C₆ alkyl, or C₁ to C₆ hydroxyalkyl, and Y is O or N.

4. The method according to claim 1 wherein said at least one sufonate functionality comprises at least one structural unit derived from at least one sulfonate monomer having the general formula (IV): 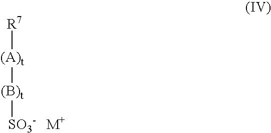
wherein R⁷ is a group comprising at least one sp² bond, A is O, N, P, S or an amido or ester linkage, B is a mono- or polycyclic aromatic group or an aliphatic group, each t is independently 0 or 1, and M⁺ is a cation.

5. The method according to claim 4 wherein R⁷ is selected from the group consisting of a C₂ to C₆ alkene, ethane, butene, propene, and combinations thereof.

6. The method according to claim 1 wherein said polymer has a weight-average molecular weight of less than or equal to about 100,000 Da.

7. The method according to claim 1 wherein said polymer comprises less than or equal to about 2 mole % of said sulfonate functionality.

8. The method according to claim 7 wherein said polymer comprises: (a) from about 0.01 mole % to about 2 mole % of a sulfonate functionality; and (b) less than or equal to about 99.99 mole % of a carboxylic acid functionality.

9. The method according to claim 8 wherein said sulfonate functionality comprises one or more of the following: sodium (meth) allyl sulfonate, vinyl sulfonate, sodium phenyl (meth) allyl ether sulfonate, 2-acrylamido-methyl propane sulfonic acid, and combinations thereof.

10. The method according to claim 8 wherein said at least one carboxylic acid functionality is selected from the group consisting of acrylic acid, maleic acid, itaconic acid, methacrylic acid, ethoxylate esters of acrylic acids, and combinations thereof.

11. The method according to claim 1 wherein said polymer comprises (a) from about 99.98% to about 48% of a carboxylic acid functionality, (b) from 0.01% to about 50% of a nonionic functionality; and (c) from about 0.01% to less than or equal to 2% of a sulfonate functionality.

12. The method according to claim 1 wherein said at least one nonionic functionality is selected from the group consisting of methyl (meth) acrylate, ethyl (meth) acrylate, t-butyl (meth) acrylate, methyl (meth) acrylamide, ethyl (meth) acrylamide, t-butyl (meth) acrylamide, styrene, α-methyl styrene, and combinations thereof.

13. The method according to claim 12 wherein said nonionic functionality contains an aromatic moiety.

14. The method according to claim 13 wherein said aromatic moiety is styrene.

15. The method according to claim 1 wherein said polymer does not contain an ester and/or amide functionality.

16. The method according to claim 1 wherein said surface-treating composition is provided in one of the following forms: solid, granule, powder, liquid, paste, cream, gel, or liquigel.

17. The method according to claim 16 wherein said surface-treating composition is provided in a unitized dose in one of the following forms: tablet, gel pack, capsule, multi-compartment capsule, water-soluble pouch, or multi-compartment pouch.

18. The method according to claim 1 wherein said at least one adjunct ingredient comprises one or more of the following: aesthetic agents, anti-filming agents, antiredopsition agents, anti-spotting agents, beads, binders, bleach activators, bleach catalysts, bleach stabilizing systems, bleaching agents, brighteners, buffering agents, builders, carriers, chelants, color speckles, control release agents, corrosion inhibitors, clays, dishcare agents, disinfectant, dispersant agents, dispersant polymers, draining promoting agents, drying agents, dyes, dye release inhibiting agents, enzymes, enzyme stabilizing systems, fillers, free radical inhibitors, fungicides, germicides, hydrotropes, opacifiers, perfumes, pH adjusting agents, pigments, processing aids, silicates, soil release agents, suds suppressors, surfactants, stabilizers, and thickeners.

19. The method according to claim 18 wherein said at least one adjunct ingredient comprises chlorine bleach.
